(19) United States
(12) Patent Application Publication
(10) Pub. No.: US 2018/0316741 A1
(43) Pub. Date: Nov. 1, 2018

(54) Synthetic Transaction based on Network Condition

(71) Applicant: Microsoft Technology Licensing, LLC, Redmond, WA (US)

(72) Inventors: Amer Aref HASSAN, Kirkland, WA (US); Danny LEVIN, Tel Aviv (IL); Russell A. PENAR, Highlands Ranch, CO (US)

(73) Assignee: Microsoft Technology Licensing, LLC, Redmond, WA (US)

(21) Appl. No.: 15/583,555

(22) Filed: May 1, 2017

(51) Int. Cl. H04L 29/06; H04L 12/26

(52) U.S. Cl. CPC H04L 65/80; H04L 43/0894; H04L 65/602; H04L 43/0823; H04L 65/4069; H04L 43/16

(57) ABSTRACT

Techniques for a synthetic transaction based on a network condition are described. According to various implementations, a synthetic transaction represents a simulation of a communication session between different communication endpoints. Whether and/or how to perform a synthetic transaction is determined based on a network condition, such as an amount of traffic on a network, packet quality on a network, and so forth.

### BACKGROUND

Modern communication systems have an array of capabilities, including integration of various communication modalities with different services. For example, communication modalities available to users include voice/video communications, instant messaging, data/application sharing, white-boarding, and presence. Furthermore, collaboration systems that enable users to share and collaborate in creating and modifying various types of documents and content may be integrated with multimodal communication systems providing different kinds of communication and collaboration capabilities. Such integrated systems are sometimes referred to as Unified Communication (UC) systems.

While UC systems provide for increased flexibility in communications, they also present a number of implementation challenges. For instance, a UC system typically utilizes multiple interconnected networks to route various communications. Since different networks may be managed by different entities, challenges thus arise in maintaining communications quality for communications that are routed among independently managed networks. Further, UC is typically implemented via software that can be loaded on mobile devices, e.g., tablets, smartphones, laptops, and so forth. Thus, techniques for managing UC&C communication traffic typically have to be fluid and dynamic to accommodate changing connection scenarios.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Techniques for a synthetic transaction based on a network condition are described. According to various implementations, a synthetic transaction represents a simulation of a communication session between different communication endpoints. Whether and/or how to perform a synthetic transaction is determined based on a network condition, such as an amount of traffic on a network, packet quality on a network, and so forth.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation that is operable to employ techniques discussed herein.

FIG. 2 illustrates an example implementation scenario for ascertaining whether and how to perform a synthetic transaction in accordance with one or more implementations.

FIG. 3 illustrates an example implementation scenario for causing a synthetic transaction to occur in accordance with one or more implementations.

FIG. 4 illustrates an example implementation scenario for reporting behaviors and performance attributes that are observed as part of a synthetic transaction in accordance with one or more implementations.

FIG. 5 is a flow diagram that describes steps in a method for ascertaining whether and/or how to initiate a synthetic transaction in accordance with one or more implementations.

FIG. 6 is a flow diagram that describes steps in a method for considering a bandwidth constraint in performing a synthetic transaction in accordance with one or more implementations.

FIG. 7 is a flow diagram that describes steps in a method for causing a synthetic transaction to be performed in accordance with one or more implementations.

FIG. 8 is a flow diagram that describes steps in a method for performing a synthetic transaction in accordance with one or more implementations.

FIG. 9 is a flow diagram that describes steps in a method for logging attributes of a synthetic transaction in accordance with one or more implementations.

FIG. 10 is a flow diagram that describes steps in a method for performing an optimization procedure based on an attribute of a synthetic transaction in accordance with one or more implementations.

FIG. 11 is a flow diagram that describes steps in a method for modifying a rate of synthetic transactions in accordance with one or more implementations.

FIG. 12 is a flow diagram that describes steps in a method for performing a synthetic transaction in accordance with one or more implementations.

FIG. 13 illustrates an example system and computing device as described with reference to FIG. 1, which are configured to implement implementations of techniques described herein.

### DETAILED DESCRIPTION

Techniques for a synthetic transaction based on a network condition are described. According to various implementations, a synthetic transaction represents a simulation of a communication session between different communication endpoints. Generally, a “communication endpoint” refers to various devices that may communicate via exchange of communication media, such as voice data, video data, content sharing, and combinations thereof.

A communication session refers to an exchange of live communication media between communication endpoints, such as part of a real-time communication session between users of different communication endpoints. Examples of a communication session include a Voice over Internet Protocol (VoIP) call, a video call, text messaging, a file transfer, and/or combinations thereof. In at least some implementations, a communication session represents a Unified Communications (UC) session. Thus, a synthetic transaction simulates conditions of an actual communication session without requiring users to be present to input communication media of the synthetic transaction.

According to various implementations, a network condition is considered as part of initiating a synthetic transaction over a network. For instance, if bandwidth usage for non-synthetic transaction related data is at a threshold bandwidth, a synthetic transaction may be cancelled or delayed. Further, a bandwidth usage and/or data size of a synthetic transaction may be determined based on a network condition, such as based on a percentage of bandwidth currently in use on a network, and/or a percentage of total estimated bandwidth capacity of the network.

According to various implementations, a simulation scenario is generated that includes various transaction parameters for a synthetic transaction. Examples of such transaction parameters include identifiers for communication endpoints, media types, device settings, and so forth, to be applied and/or simulated as part of a synthetic transaction. Generally, the simulation scenario can simulate different communication session types and/or conditions, such as person-to-person calls, conference calls, multicast calls, and so forth. A synthetic transaction can be performed between different communication endpoints and based on the transaction parameters.

According to various implementations, performance attributes of a synthetic transaction may be recorded during various stages of the synthetic transaction. The performance attributes, for instance, may indicate call quality and/or errors that occur during the synthetic transaction. Based on the performance attributes, various actions may be taken to mitigate errors and optimize communication session performance. For instance, the performance attributes can be communicated to different entities involved in the synthetic transaction, such as network managers, communication services, end-user devices, and so forth. The respective entities may implement various corrective and optimization procedures based on the performance attributes.

In the following discussion, an example environment is first described that is operable to employ techniques described herein. The next section discusses some example ways for communicating parameters for and observations of synthetic transactions. The section following this discusses some example implementation scenarios in accordance with one or more implementations. The proceeding section describes some example procedures in accordance with one or more implementations. The final section discusses an example system and device that are operable to employ techniques discussed herein in accordance with one or more implementations.

Having presented an overview of example implementations in accordance with one or more implementations, consider now an example environment in which example implementations may by employed.

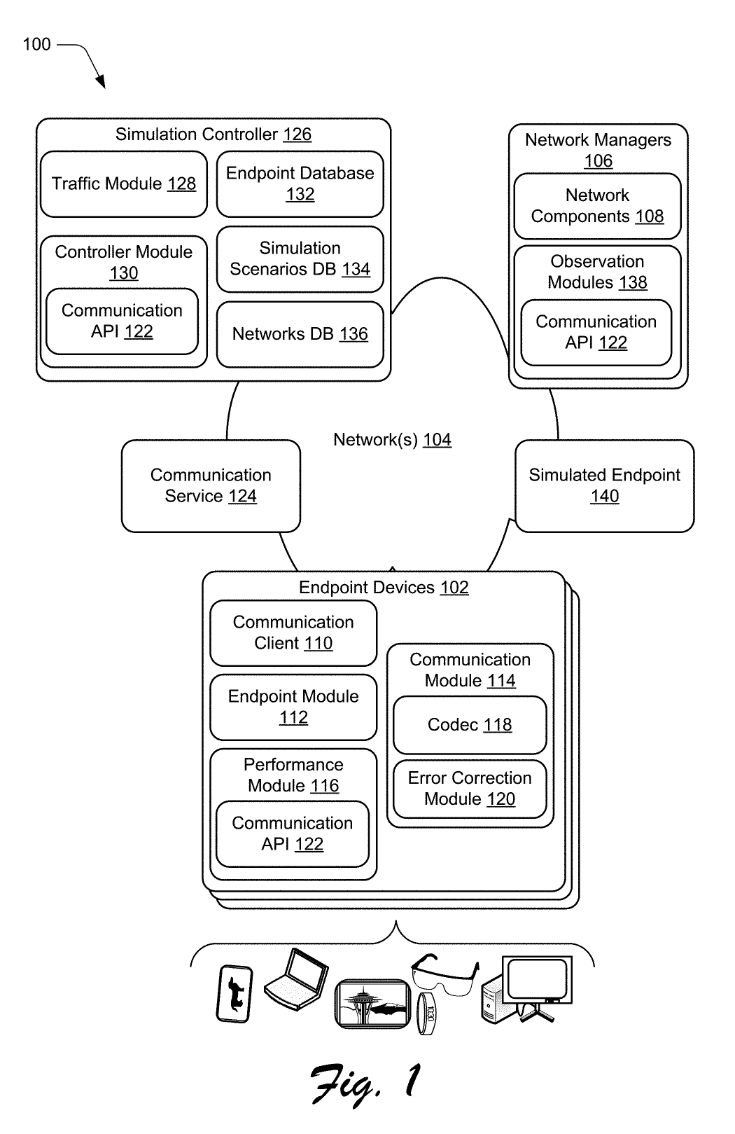

FIG. 1 is an illustration of an environment 100 in an example implementation that is operable to employ techniques for a synthetic transaction based on a network condition described herein. Generally, the environment 100 includes various devices, services, and networks that enable communication via a variety of different modalities. For instance, the environment 100 includes endpoint devices 102 connected to networks 104. Generally, the endpoint devices 102 may be configured in a variety of ways, such as a traditional computer (e.g., a desktop personal computer, laptop computer, and so on), a smartphone, an Internet Protocol (IP) phone, a wearable device, a netbook, a handheld device (e.g., a tablet), an entertainment appliance, a game console, and so forth.

The networks 104 provide the endpoint devices 102 with connectivity to various networks and/or services, such as the Internet. The networks 104, for instance, enable data to be transmitted via wired and/or wireless connections between the endpoint devices 102. The networks 104 may be implemented via a variety of different instances and combinations of connectivity technologies, such as wireless cellular, broadband cable, digital subscriber line (DSL), wireless data connectivity (e.g., WiFi™), T-carrier (e.g., T1), Ethernet, and so forth. In at least some implementations, the networks 104 represent different interconnected wired and wireless networks.

The networks 104 are provided and/or managed by network managers 106, which are representative of different entities that provide infrastructure and administration of the networks 104. The network managers 106, for instance, provide and maintain network components 108, which are representative of hardware and logic for implementing the networks 104. Examples of the network components 108 include gateways, switches, routers, hubs, wireless access points, network elements, and so forth.

The endpoint devices 102 include a variety of different functionalities that enable various activities and tasks to be performed. For instance, the endpoint devices 102 include a communication client 110, an endpoint simulator module (“endpoint module”) 112, a communication module 114, and a performance module 116. The communication client 110 is representative of functionality to enable different forms of communication via the endpoint devices 102, such as for communication between different instances of the endpoint devices 102. Examples of the communication client 110 include a voice communication application (e.g., a VoIP client), a UC client, a video communication application, a messaging application, a content sharing application, and combinations thereof. The communication client 110, for instance, enables different communication modalities to be combined to provide diverse communication scenarios. In at least some implementations, the communication client 110 represents an application that is installed on the endpoint devices 102. Additionally or alternatively, the communication client 110 can be implemented as a portal to a remote application, such as accessed via a web browser, a web application, and so forth.

According to one or more implementations, communication between different instances of the endpoint devices 102 occurs between different instances of the communication client 110. For example, a communication session between different endpoint devices 102 represents an exchange of communication media between different instances of the communication client 110. In at least some implementations, the communication client 110 represents an application that executes at an application layer of the endpoint devices 102.

The endpoint module 112 is representative of functionality to implement synthetic transactions, such as to generate and/or participate in synthetic transactions. Further details and functionality of the endpoint module 112 are described below. The communication module 114 is representative of functionality for enabling the endpoint devices 102 to communicate via wireless and/or wired data transmission over the networks 104. For instance, the communication module 114 represents hardware and logic for data communication over the networks 104 via a variety of different wired and wireless technologies and protocols.

The communication module 114 includes a codec 118 and an error correction module 120. Generally, the codec 118 is representative of functionality for encoding and decoding data streams, such as part of communication sessions between the endpoint devices 102. The error correction module 120 is representative of functionality to apply various types of error correction to data streams transmitted and received by the endpoint devices 102. Examples of error correction that are applicable by the error correction module 120 include forward error correction (FEC), data interleaving, cyclical redundancy checks (CRC), cryptographic protocols, and so forth.

According to various implementations, the codec 118 and the error correction module 120 can be configured in a variety of different ways to account for varying signal quality on the networks 104. The communication module 114 may include other components not expressly illustrated herein, such as an encryption module for encrypting and decrypting data, a radio frequency (RF) modulator for modulating and demodulating data, RF components (e.g., antennas, radios, and so forth) for transmitting and receiving RF signal, and so forth.

The performance module 116 is representative of functionality for receiving communication attributes from other entities, and for sharing communication attributes with other entities. According to various implementations, the performance module 116 utilizes a communication application programming interface (API) 122 to enable various communication attributes to be shared. The communication API 122, for example, can be populated with various communication attributes to enable the communication attributes to be shared with various entities involved in communication sessions. For instance, and as detailed below, communication attributes can be determined based on a synthetic transaction, and can be populated to the communication API 122 for sharing with other entities.

The environment 100 further includes a communication service 124, which is representative of a service to perform various tasks for management of communication between the endpoint devices 102. The communication service 124, for instance, can manage initiation, moderation, and termination of communication sessions. Examples of the communication service 124 include a VoIP service, an online conferencing service, a UC service, and so forth. In at least some implementations, the communication service 124 may be implemented as or be connected to a private branch exchange (PBX) in communication with a Public Switched Telephone Network (“PSTN”) to enable voice communication between the endpoint devices 102.

According to one or more implementations, the communication client 110 is managed and/or hosted by the communication service 124. For instance, the communication client 110 represents an interface to communication services provided by the communication service 124.

The environment 100 further includes a simulation controller 126, which is representative of functionality to perform various aspects of techniques for a synthetic transaction based on a network condition discussed herein. The simulation controller 126, for instance, can implement synthetic communication transactions (“synthetic transactions”) that simulate various communication scenarios, such as communication between different instances of the endpoint devices 102. In at least some implementations, the simulation controller 126 is implemented by the communication service 124 to determine and manage various aspects of communication quality between different communication endpoints.

The simulation controller 126 includes a traffic detection module (“traffic module”) 128, a controller simulator module (“controller module”) 130, an endpoint database (DB) 132, and a simulation scenarios database (DB) 134. The traffic module 128 is representative of functionality to determine network traffic conditions on different networks 104. In at least some implementations, the traffic module 128 can determine network conditions via direct network testing. Alternatively or additionally, the traffic module 128 can determine network conditions based on information received from a remote source, such as the network managers 106 and/or the endpoint devices 102. As detailed herein, network conditions determined by the traffic module 128 can be utilized to control whether and how to perform a synthetic transaction.

The controller module 130 is representative of functionality for generating synthetic transactions and for interfacing with other devices to implement synthetic transactions. The controller module 130, for instance, can generate synthetic transactions and can cause the synthetic transactions to be performed over the networks 104. The controller module 130 may also interface with the endpoint module 112 on the endpoint devices 102 to cause the endpoint module 112 to implement synthetic transactions. For instance, based on a simulation scenario from the simulation scenarios DB 134, the controller module 130 communicates transaction parameters to the endpoint module 112. The endpoint module 112 may then use the transaction parameters to implement a synthetic transaction, such as to simulate a communication session between different endpoint devices 102.

According to various implementations, the controller module 130 is configured to utilize the communication API 122 to configure synthetic transactions and to share communication attributes with other entities, such as the endpoint devices 102 and/or the network managers 106. Examples of different communication attributes that can be shared via the communication API 122 are discussed in detail below.

According to one or more implementations, different instances of the simulation controller 126 can be distributed over different networks, and thus the different simulation controllers 126 can interact to cause synthetic transactions to be performed over the different networks.

The endpoint DB 132 stores information about different communication endpoints, such as the endpoint devices 102. For instance, the endpoint DB 132 correlates identifiers for different endpoint devices 102 with results of synthetic transactions that involve the endpoints. The simulation scenarios DB 134 stores simulation parameters and attributes that can be used to generate different synthetic transactions.

According to one or more implementations, the simulation controller 126 includes connectivity and logic that accesses routing information for communications between the endpoint devices 102. For instance, the simulation controller 126 can access an Interior Gateway Protocol (IGP) and/or spanning tree switching topology for the networks 104, e.g., for the network components 108. This enables the simulation controller 126 to identify different network components 108 that are involved in routing synthetic transaction data, and to identify particular network components 108 that may cause various performance-related phenomena detected as part of a synthetic transaction. According to various implementations, the simulation controller 126 stores connectivity and performance attributes of different networks 104 and/or network components 108 as part of a networks database (DB) 136.

The networks DB 136, for instance, indicates performance data for individual networks 104 and/or network components 108, such as indications of data flow (e.g., packet) quality on the individual networks and/or components. For example, individual of the networks 104 and/or network components 108 can be characterized in the networks DB 136 based on historical quality metrics, such as detected as part of synthetic transactions that involve particular networks 104. In at least some implementations, the simulation controller 126 maintains active state awareness of the networks 104 via the networks DB 136 and based on session quality attributes of different networks 104 and/or network components 108 that are detected as part of a synthetic transaction. Data from the networks DB 136 can be provided to the network managers 106 to enable particular network components 108 to be reconfigured, repaired, or replaced to increase communication quality on various communication paths of the networks 104. Data from the networks DB 136 may also be provided to the endpoint devices 102 to enable the endpoint devices 102 to make various configuration changes to optimize data communication on the networks 104.

According to various implementations, the network managers 106 maintain observation modules 138, which are representative of functionality to observe and record behaviors that occur within the networks 104. For instance, an individual network manager 106 may maintain an observation module 138 that observes and records performance attributes of data flows for a synthetic transaction that occurs on a respective network 104. The observation modules 138 may propagate behavior information for respective networks 104 and/or network components 108 to the simulation controller 126 to be stored by the networks DB 136. The observation modules 138, for example, are configured to utilize the communication API 122 to populate and share network information determined from synthetic transactions. In at least some implementations, the observation modules 138 may be deployed and/or hosted in their respective networks 104 by the simulation controller 126.

The environment 100 further includes a simulated endpoint 140, which is representative of functionality to simulate a communication endpoint. For instance, the simulated endpoint 140 may be implemented as a logical representation of an end-user device via which synthetic transactions may be performed. The simulation controller 126, for example, may implement a synthetic transaction between an endpoint device 102 and the simulated endpoint 140 to simulate different conditions that may occur as part of a communication session. In at least some implementations, the simulated endpoint 140 is configured to engage in a synthetic transaction with an endpoint device 102 and/or other communication endpoint independent of user input to and/or control of the simulated endpoint 140.

The various entities and functionalities discussed in the environment 100 may be implemented in software, hardware, firmware, and/or combinations thereof. Further details and implementations of the various entities of the environment 100 are discussed below.

Having described an example environment in which the techniques described herein may operate, consider now a discussion of example ways of propagating various attributes of communication sessions in communication systems in accordance with one or more implementations.

According to various implementations, techniques can be employed to generate simulation scenarios for synthetic transactions with a wide variety of different parameters. For instance, notification events can be generated that specify various transaction parameters to be applied as part of synthetic transactions. The notification events can be conveyed to different entities to be used to implement synthetic transactions according to techniques for a synthetic transaction based on a network condition discussed herein.

In at least some implementations, notification events can be configured using the communication API 122 that can be leveraged to configure and communicate parameters for synthetic transactions to various entities. Consider, for instance, the following parameters that may be conveyed via notification events:

(1) Media Type: This parameter can be used to specify a media type and/or types that are to be transmitted and/or simulated as part of a synthetic transaction. Examples of media type include voice data (e.g., audio), video, content, and combinations thereof.

(2) Initiator Address(es): This parameter can be used to specify addresses for endpoints that are to initiate a synthetic transaction. Examples of addresses include media access control (MAC) addresses, Internet protocol (IP) addresses, usernames, phone numbers, and so forth.

(3) Recipient Address(es): This parameter can be used to specify addresses for endpoints that are to “called” as part of a synthetic transaction. In at least some implementations, multiple recipient addresses can be indicated, such as for conference calls, multicast communication events, and so forth.

(4) Codecs: This parameter can be used to specify a codec/codecs to be used to implement a synthetic transaction. Additionally or alternatively, the parameter can be employed to specify codec settings, such as a bit rate for a codec or set of codecs involved in a communication session.

(5) Communication Client Settings: This parameter can be used to specify various communication client settings to be applied and/or simulated as part of a synthetic transaction.

(6) Quality of Service: This parameter can be used to specify quality of service (QoS) to be applied to communication media as part of a synthetic transaction. The attribute, for instance, can specify QoS markings to be applied to communication media. Examples of QoS markings include best effort (BE), expedited forwarding (EF), assured forwarding (AF), and so forth.

(7) Transaction Routing: This parameter can be used to specify specific routes to be used as part of a synthetic transaction. A route, for instance, can be specified in terms of specific instances of network components, such as specific gateways, servers (e.g., UC servers), UC networks, and so forth.

(8) Transaction Type: This parameter can be used to specify different transaction types, such as calls between two devices, conference calls, call multi-forking, multi-cast calls, and so forth.

(9) Transaction Behaviors: This parameter can be used to specify different behaviors that may occur during and/or as part of a transaction, such as user-initiated behaviors, communication service behaviors, device behaviors, and so forth. Examples of transaction behaviors include selection of different communication options, such as placing a call on hold, adjustment of call volume, selecting a call recording option, transferring a call to a different user and/or device, and so forth.

(10) Transaction Timing: This parameter can be used to specify various temporal parameters of a synthetic transaction, such as a date and/or time when a synthetic transaction is to be initiated, a time duration for a synthetic transaction, timing for particular events that occur during a synthetic transaction, and so forth.

According to various implementations, these transaction parameters can be employed to generate different simulation scenarios that are stored as part of the simulation scenarios DB 136. These transaction parameters are presented for purpose of example only, and it is to be appreciated that a wide variety of different parameters not expressly mentioned herein may additionally or alternatively be employed in accordance with the claimed implementations.

In at least some implementations, notification events can be generated that identify behaviors that are observed as part of synthetic transactions. Notification events, for instance, can be configured using the communication API 122 that can be leveraged to communicate synthetic transaction behaviors that are observed to various entities. For example, the communication API 122 can identify dialogue events and session events for which attributes of a synthetic transaction can be identified. Consider, for instance, the following events and attributes that may be conveyed via a notification event:

Dialogue Events—These events apply to various portions of a synthetic transaction, such as the start, update, and end of a synthetic transaction. A dialogue event can include one or more of the following example attributes.

(1) Timestamp: This attribute can be leveraged to specify timestamps for a start of a synthetic transaction, updates that occur during a synthetic transaction, and an end (e.g., termination) of a synthetic transaction.

(2) Source IP Address: This attribute can be leveraged to specify an IP address for an endpoint that is a source of media during a synthetic transaction, e.g., a device that initiates a synthetic transaction.

(3) Destination IP Address: This attribute can be leveraged to specify an IP address for an endpoint that is to receive media as part of a synthetic transaction.

(4) Transport Type: This attribute can be leveraged to specify a transport type or combination of transport types for a synthetic transaction. Examples of transport types include Transmission Control Protocol (TCP), User Datagram Protocol (UDP), and so forth.

(5) Source Port: this attribute can be leveraged to specify an identifier for a port at a source endpoint, e.g., a source device identified by the Source IP Address referenced above.

(6) Destination Port: This attribute can be leveraged to specify an identifier for a port at a destination endpoint, e.g., a destination device identified by the Destination IP Address referenced above.

(7) Media Type: This attribute can be leveraged to specify a media type and/or types that are to be transmitted and/or are being transmitted as part of a synthetic transaction. As discussed elsewhere herein, a synthetic transaction can involve multiple different types of media. Thus, the Media Type attribute can be employed to identify media types that are exchanged as part of a synthetic transaction.

(8) Bandwidth Estimation: This attribute can be leveraged to specify an estimated bandwidth that is allocated as part of a synthetic transaction.

(9) To: This attribute can be leveraged to identify a user to which media in a synthetic transaction is transmitted.

(10) From: This attribute can be leveraged to identify a user from which media synthetic transaction is transmitted.

(11) Error Code: This attribute can be leveraged to specify various error codes for errors that may occur as part of a synthetic transaction. For example, errors can include errors that occur during initiation of a synthetic transaction, errors that occur during a synthetic transaction, errors that occur when a synthetic transaction is terminated, and so forth.

Transaction Performance Events—These events can be generated and applied to specify various behaviors and performance parameters that are observed as part of a synthetic transaction. A transaction performance event may include one or more of the attributes discussed above with reference to Dialogue Events, and may also include one or more of the following attributes.

(1) Mean Opinion Score (MOS) Degradation: This attribute can be leveraged to specify a MOS for a synthetic transaction. The attribute, for instance, can be used to indicate an overall quality metric for a synthetic transaction.

(2) Jitter Inter-Arrival Time: This attribute can be leveraged to specify jitter values for a synthetic transaction.

(3) Packet Loss Rate: This attribute can be leveraged to specify a packet loss rate for a synthetic transaction.

(4) Round Trip Delay (RTD): This attribute can be leveraged to specify RTD values for packets in synthetic transaction.

(5) Concealment Ratio: This attribute can be leveraged to indicate an observed cumulative ratio of concealment time over speech time observed for a synthetic transaction.

Thus, various notifications discussed herein can include one or more of the attributes discussed above and can be used to propagate the attributes to various entities. This list of attributes is not exhaustive, and it is to be appreciated that a wide variety of other attributes may be communicated in accordance with the claimed implementations.

Having described an example ways of propagating parameters and observed behaviors of synthetic transactions, consider now some example implementation scenarios for a synthetic transaction based on a network condition in accordance with one or more implementations.

The following section describes example implementation scenarios for a synthetic transaction based on a network condition in accordance with one or more implementations. The implementation scenarios may be implemented in the environment 100 discussed above, and/or any other suitable environment.

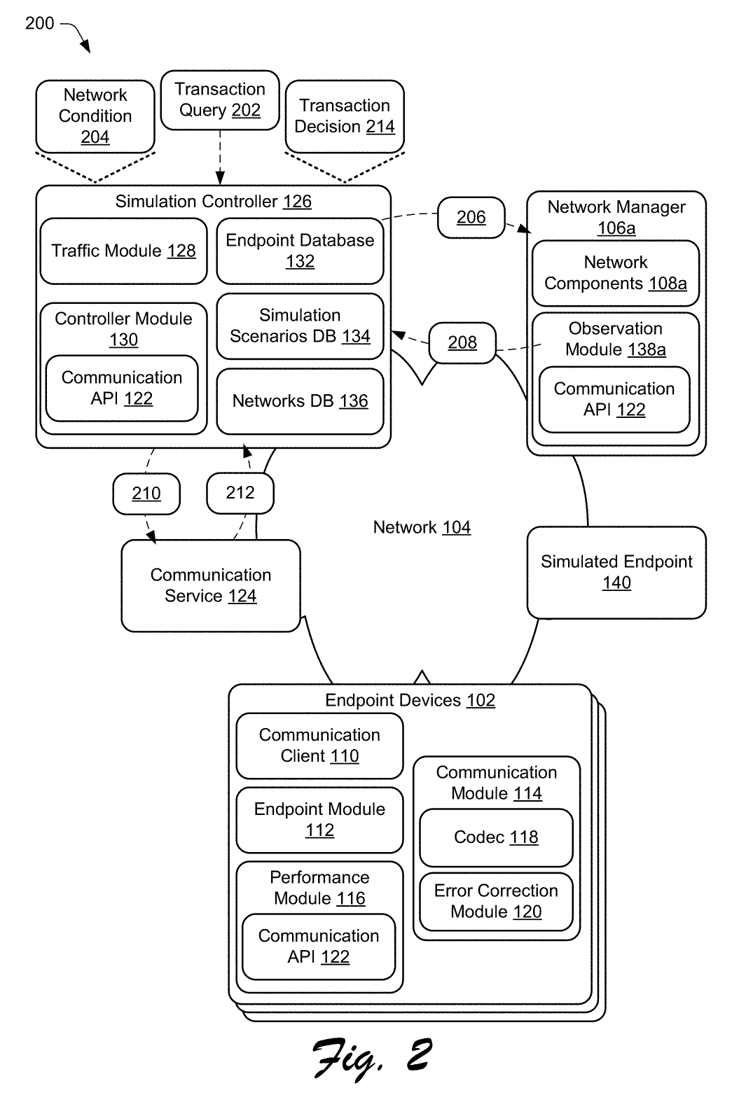

FIG. 2 illustrates an example implementation scenario 200 for ascertaining whether and how to perform a synthetic transaction in accordance with one or more implementations. In the scenario 200, the simulation controller 126 receives a transaction query 202 that represents a query to generate and perform a synthetic transaction over the network 104. The transaction query 202 may correspond to various phenomena, such as user input to the simulation controller 126, a request from the communication service 124 to perform a synthetic transaction, an automatically generated event, a timed event, an indication of an upcoming scheduled communication session, and so forth. Generally, the transaction query 202 corresponds to a prompt to the simulation controller 126 to generate and perform a synthetic transaction over the network 104.

In response to the transaction query 202, the traffic module 128 determines a network condition 204 of the network 104. In at least some implementations, the network condition 204 represents an indication of network traffic (e.g., real-time traffic) over the network 104, such as active signal transmission occurring over the network 104. The network condition 204, for example, indicates bandwidth usage for data transmission on the network 104. Alternatively or additionally, the network condition 204 indicates packet quality on the network 104. Generally, packet quality refers to various quality-related attributes, such as packet error rate (PER), jitter, dropped packet count over a period of time, and so forth.

The traffic module 128 may determine the network condition 204 in various ways. For instance, the traffic module 128 may communicate a condition query 206 to a network manager 106a for the network 104. The condition query 206, for example, requests information pertaining to network traffic and/or packet quality on the network 104. An observation module 138a for the network manager 106a returns a condition response 208 which indicates a network condition of the network 104. The condition response 208 can generally identify various network conditions of the network 104, such as estimated total bandwidth usage (e.g., active usage) over the network 104, an estimated percentage of network bandwidth capacity that is currently in use over the network 104, an indication of packet quality over the network 104, and so forth.

In at least one implementation, the condition query 208 queries whether there is sufficient available bandwidth over the network 104 for performing a synthetic transaction. Accordingly, the network manager 106a can make a determination based on its own awareness of network traffic as to whether there is sufficient bandwidth for a synthetic transaction. For instance, and as further detailed below, various criteria can be applied based on network traffic to determine whether/how to perform a synthetic transaction. Examples of such criteria include whether current network traffic exceeds a pre-specified usage threshold (e.g., a percentage of network bandwidth capacity), whether allowing a synthetic transaction would cause network usage to exceed an allowed amount of bandwidth usage, and so forth. The network manager 106a can indicate in the condition response 208 whether a synthetic transaction is permitted over the network 104.

As another example, the traffic module 128 can determine the network condition 204 based on observing conditions of the network 104 itself. For instance, the traffic module 128 can perform various procedures to detect network traffic and/or packet errors on the network 104, such as based on observation of and/or communication with network components 108a. Examples of such procedures include querying the network components 108a for network conditions (e.g., via Simple Network Management Protocol (SNMP) polling, Call Session Control Function (CSCF) polling, and/or other query type), performing a data ping on the network 104, and so forth.

The traffic module 128 may also determine the network condition 204 via the communication service 124. For instance, the communication service 124 manages communications (e.g., calls) on the network 104, and thus has visibility into communication traffic on the network 104. Accordingly, the traffic module 128 communicates a condition query 210 to the communication service 124 requesting information about network conditions on the network 104. The communication service 124 returns a condition response 212 which indicates a network condition, such as an amount of communication traffic on the network 104, packet quality on the network 104, and so forth. In at least some implementations, the condition response 212 can be generated based on data from the endpoint devices 102. The communication clients 110 on different endpoint devices 102, for example, can observe network conditions, such as based on calls in which the communication clients 110 participate. Accordingly, the communication clients 110 can expose this information to the communication service 124, which can use the information to generate the condition response 212.

These different ways for determining the network condition 204 are presented for purpose of example only, and it is to be appreciated that a wide variety of different ways for determining network conditions can be employed according to techniques for a synthetic transaction based on a network condition described herein.

In at least some implementations, the various communications (e.g., queries and responses) discussed in this and other scenarios can be implemented using the communication API 122. For instance, attributes of the communication API 122 discussed above can be populated with values and used to communicate various information between entities involved in the scenarios.

Continuing with the scenario 200, the simulation controller 126 generates a transaction decision 214 based on the network condition 204. Generally, the transaction decision 214 indicates whether (yes or no) a synthetic transaction is to be performed over the network 104. In at least some implementations, if the transaction decision 214 indicates that a synthetic transaction is to be performed, the transaction decision 214 may also specify parameters for the synthetic transaction, such as a permitted bandwidth and/or data size of the synthetic transaction, a permitted time duration of the synthetic transaction, a date and/or time during which the synthetic transaction is permitted to be performed, and so forth.

In at least some implementations, the transaction decision 214 indicates that a synthetic transaction is not to be performed. For instance, the network condition 204 may indicate that current traffic over the network 104 exceeds a threshold amount of traffic. Thus, a synthetic transaction is not currently permitted, such as to avoid further loading of network capabilities.

However, if the transaction decision 214 indicates that a synthetic transaction is to be performed, the simulation controller 126 proceeds with initiating a synthetic transaction. Consider, for example, the following scenario.

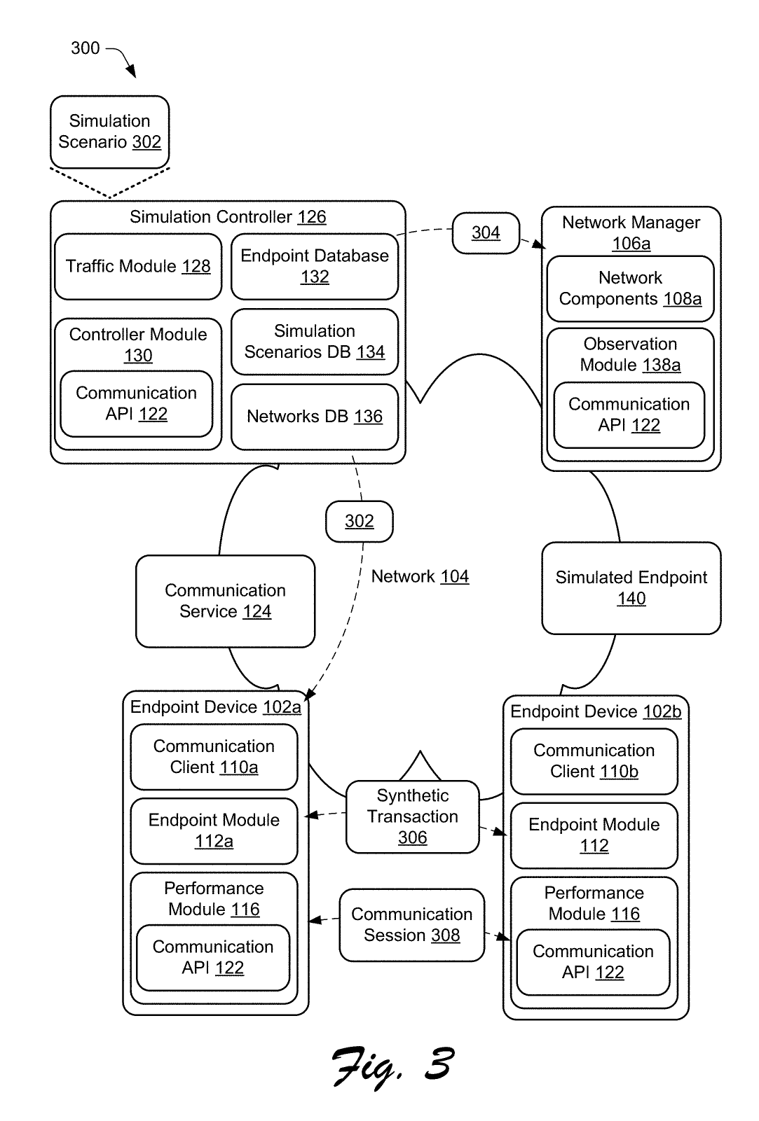

FIG. 3 depicts an example implementation scenario 300 for causing a synthetic transaction to occur. The scenario 300, for instance, represents a continuation of the scenario 200. In the scenario 300, the controller module 130 generates a simulation scenario 302 that indicates various parameters to be applied and/or simulated as part of a synthetic transaction. The simulation scenario 302, for example, is generated in response to the transaction decision 214 indicating that a synthetic transaction is to be performed. Examples of different parameters that can be included in the simulation scenario 302 are discussed above. The simulation scenario 302 may be generated in various ways, such as based on user input to the simulation controller 126, automatically in response to the transaction query 202, and so forth. In at least some implementations, the simulation scenario 302 may correspond to a preconfigured scenario from the simulation scenarios DB 134. Alternatively or additionally, the simulation scenario 302 may be dynamically generated, such as based on a detected event or network condition.

In this particular scenario, the simulation scenario 302 indicates that a synthetic transaction is to be performed between an endpoint device 102a and an endpoint device 102b, which generally represent different instances of the endpoint devices 102. Accordingly, the simulation controller 126 communicates the simulation scenario 302 to the endpoint device 102a. An endpoint module 112a on the endpoint device 102a parses the simulation scenario 302 to identify the various transaction parameters specified in the simulation scenario 302. The simulation scenario 302, for instance, indicates that the endpoint device 102a is to initiate a synthetic transaction with the endpoint device 102b over the network 104.

According to various implementations, the simulation controller 126 also communicates a transaction notification 304 to the network manager 106a for the network 104. The transaction notification 304, for instance, notifies the observation module 138a that a synthetic transaction is being initiated over the network 104 and that the observation module 138a is to observe and record data flow behaviors for the synthetic transaction on respective network components 108a. The transaction notification 304 includes various information that enables the observation module 138a to distinguish data of the synthetic transaction from other data flows, such as identifiers for the endpoint devices 102a, 102b, a stream identifier that identifies data of the synthetic transaction (e.g., a packet identifier), and so forth.

Further to the scenario 300, the endpoint module 112a initiates a synthetic transaction 306 between the endpoint device 102a and the endpoint device 102b. Generally, the synthetic transaction 306 represents an exchange of communication media between the endpoint devices 102a, 102b. The synthetic transaction 306, for instance, is a real-time exchange of simulated communication media that simulates a real-time communication session between users of the endpoint devices 102a, 102b. In at least some implementations, communication media exchanged as part of the synthetic transaction may be included as part of the simulation scenario 302. Alternatively or additionally, the communication media may be generated by the endpoint device 102a and/or the endpoint device 102b. Other parameters and behaviors specified by the simulation scenario 302 may be applied as part of the synthetic transaction 306, examples of which are detailed above.

According to various implementations, the simulation scenario 302 may be employed to initiate a synthetic transaction between the endpoint device 102a and the simulated endpoint 140, e.g., in addition or alternatively to the endpoint device 102b. For instance, the simulation scenario 302 may identify the simulated endpoint 140, such as via a network address and/or other identifier for the simulated endpoint 140. Thus, the endpoint device 102a may initiate the synthetic transaction 306 with the simulated endpoint 140 in a similar manner as would be performed for initiating the synthetic transaction 306 with the endpoint device 102b. In at least some implementations, the simulation controller 126 may control the simulated endpoint 140 to simulate various endpoint behaviors. Alternatively or additionally, the simulated endpoint 140 may include integrated logic that enables the simulated endpoint 140 to control itself (e.g., independent of human user control) to simulate an interaction with an actual communication endpoint.

Thus, the endpoint device 102a may communicate with the simulated endpoint 140 as it would with an actual user-controlled endpoint device 102.

While the scenario 300 is discussed with reference to a synthetic transaction between the endpoint devices 102a, 102b, it is to be appreciated that techniques discussed herein may be employed to initiate and perform synthetic transactions between a variety different devices. For instance, the synthetic transaction 306 can be performed between the simulation controller 126 and one or both of the endpoint devices 102a, 102b, between the simulation controller 126 and the simulated endpoint 140, and so forth.

In at least some implementations, the synthetic transaction 306 does not include any actual live, real-time communication between human users. The synthetic transaction 306, for instance, is a purely synthetic transaction. Alternatively, the synthetic transaction 306 can be linked to a real-time communication between users of the endpoint devices 102a, 102b. For example, consider a scenario where a user of the endpoint device 102a initiates a communication session 308 between the endpoint device 102a and the endpoint device 102b. In at least some implementations, the communication session 308 represents a real-time exchange of live communication media, such as between a communication client 110a of the endpoint device 102a and a communication client 110b of the endpoint device 102b. Accordingly, the synthetic transaction 306 can be appended to the communication session 308. For instance, media data of the synthetic transaction 306 can be appended to media data of the communication session 308. Thus, the synthetic transaction 306 can be considered a hybrid synthetic transaction that is implemented as a media stream that includes both non-real time communication media of the synthetic transaction 306 and real-time communication media of the communication session 308.

Various behavioral data surrounding the synthetic transaction 306 is collected by entities involved in the synthetic transaction 306, such as detailed in the following scenario.

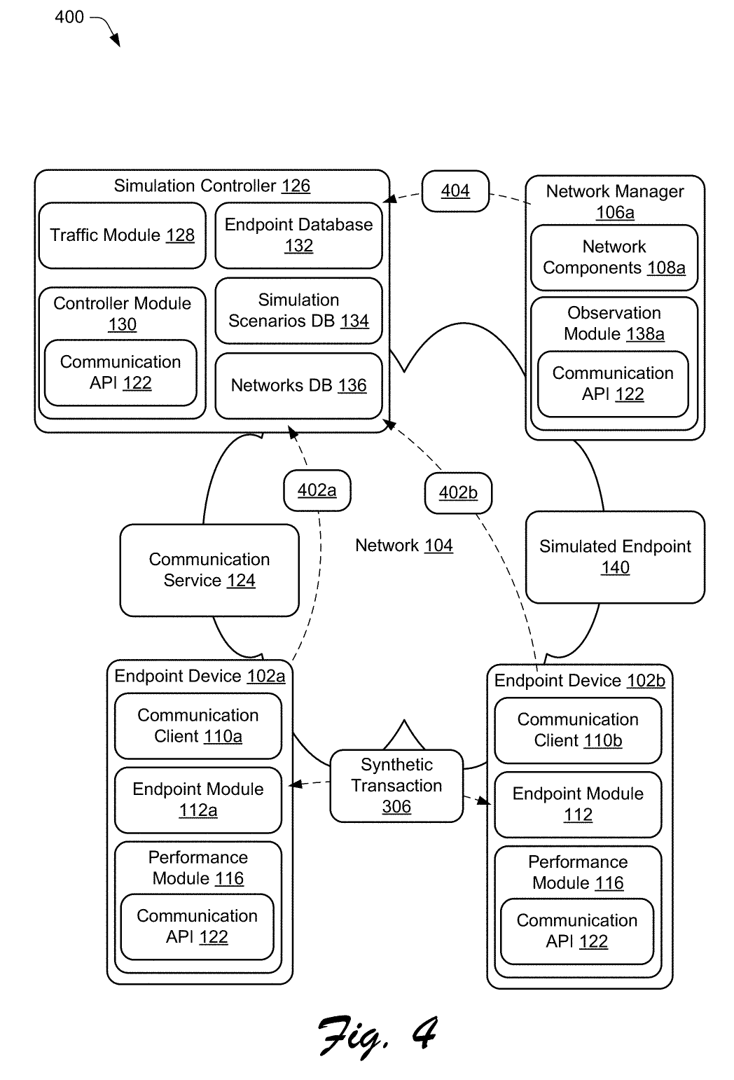

FIG. 4 illustrates an example implementation scenario 400 for reporting behaviors and performance attributes that are observed as part of a synthetic transaction in accordance with one or more implementations. In at least some implementations, the scenario 400 represents a continuation of the scenarios 200, 300.

In the scenario 400, endpoint device 102a communicates a transaction report 402a to the simulation controller 126. Generally, the transaction report 402a includes various behaviors and performance attributes that are observed as part of the synthetic transaction 306. Examples of behaviors and attributes specified in the transaction report 402a include queue handling, endpoint device 102a configuration, data routing, failure handling attributes, jitter attributes, packet latency, packet loss, and so forth. The transaction report 402a, for instance, can be populated with attributes and values based at least partially on the communication API 122 discussed above.

According to various implementations, the transaction report 402a can be generated and communicated in various ways. For instance, the endpoint module 112a can populate the transaction report 402a with different attributes and values during initiation, performance, and termination of a synthetic transaction. The endpoint device 102a, for example, can communicate the transaction report 402a to the simulation controller 126 after termination of the synthetic transaction 306.

Alternatively or additionally, the transaction report 402a can be communicated to the simulation controller 126 dynamically and during different stages of a synthetic transaction, e.g., during initiation, performance, and/or termination of a synthetic transaction. For instance, different instances of the transaction report 402a can be communicated (e.g., periodically) to the simulation controller 126 at different points of a synthetic transaction, with individual transaction reports 402a being updated based on recently observed behaviors and attributes of a synthetic transaction.

Further to the scenario 400, the endpoint device 102b communicates an transaction report 402bb to the simulation controller 126. According to various implementations, the transaction report 402bb includes various attributes and behaviors observed at the endpoint device 102b as part of the synthetic transaction 306. The transaction report 402bb, for example, may be populated and/or communicated similarly to the transaction report 402a, but with values and attributes observed at the endpoint device 102b.

Continuing with the scenario 400, the network manager 106a communicates a network report 404 to the simulation controller 126. According to various implementations, the network report 404 includes various attributes and behaviors observed by the network manager 106a as part of the synthetic transaction 306 over the network 104. The network report 404, for example, may be populated and/or communicated similarly to the transaction reports 402a, 402b, but with values and attributes observed over the network components 108a by the network manager 106a. In implementations where multiple networks are involved in a synthetic transaction, individual network managers 106 for the involved networks may communicate individual respective network reports 404 that are populated with attributes and behaviors observed at the respective networks 104.

According to various implementations, the simulation controller 126 receives the different reports and processes the reports in various ways. For instance, information from the transaction reports 402a, 402b can be propagated to the endpoint DB 132. Accordingly, entries in the endpoint DB 132 for the endpoint devices 102a, 102b may be populated with information from the transaction reports 402a, 402b, respectively. Thus, the simulation controller 126 may track attributes and behaviors observed at different devices and/or endpoints as part of a synthetic transaction. Further, the endpoint DB 132 may be used to track historical performance of different devices and endpoints over multiple different synthetic transactions and over a period of time.

The simulation controller 126 also propagates information from the network report 404 to the networks DB 136. For instance, an entry in the networks DB 136 for the network 104 involved in the synthetic transaction may be populated with information from the network report 404. Thus, the simulation controller 126 may track attributes and behaviors observed at different networks 104 as part of a synthetic transaction. When multiple networks 104 are involved in a synthetic transaction, the simulation controller 126 may populate information from network reports 404 received from the different networks to entries in the networks DB 136 for the respective networks 104. In at least some implementations, the networks DB 136 may be used to track historical performance of different networks over multiple different synthetic transactions and over a period of time.

Thus, information from the different reports based on the synthetic transaction 306 may be aggregated to present a comprehensive end-to-end perspective of the synthetic transaction, as well as performance attributes of communication on the network 104.

Further to the scenario 400, information from the different reports may be propagated to different entities. For instance, the simulation controller 126 may notify the network manager 106a of behaviors and performance attributes observed at the endpoint devices 102a, 102b for the synthetic transaction 306. Further, the endpoint device 102a may be notified of performance attributes (e.g., packet quality) experienced at the endpoint device 102b, and vice-versa. Thus, end-to-end awareness of synthetic transaction behaviors and attributes enabled by techniques discussed herein may be disseminated to entities involved in synthetic transactions. Such awareness enables individual entities to repair and/or optimize components, settings, and/or processes to mitigate performance problems and increase performance quality in their respective spheres of responsibility.

While the scenarios described are discussed in the context of communication media, it is to be appreciated that techniques for a synthetic transaction based on a network condition described herein can be employed to perform synthetic transactions based on a variety of different data types and instances, such as geographical position information, machinery control information, enterprise data, and so forth.

Having discussed some example implementation scenarios, consider now a discussion of some example procedures in accordance with one or more implementations.

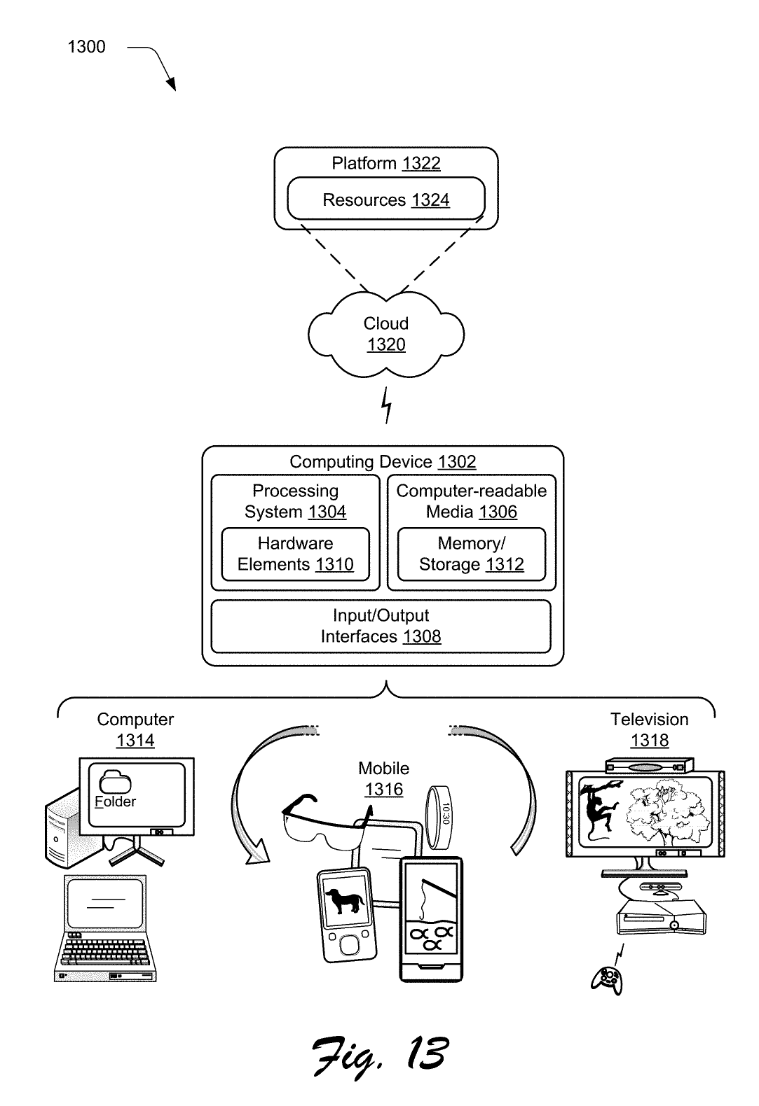

The following discussion describes some example procedures for a synthetic transaction based on a network condition in accordance with one or more implementations. The example procedures may be employed in the environment 100 of FIG. 1, the system 1300 of FIG. 13, and/or any other suitable environment. The procedures, for instance, represent procedures for implementing the example implementation scenarios discussed above. In at least some implementations, steps described for the various procedures can be implemented automatically and independent of user interaction.

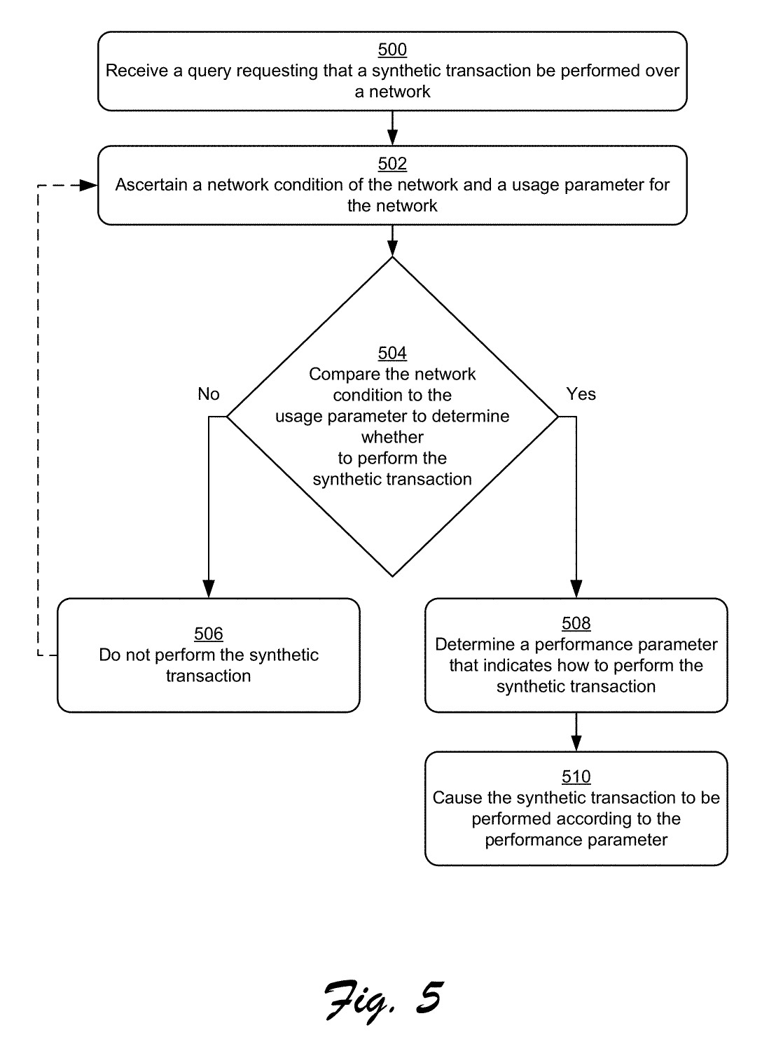

FIG. 5 is a flow diagram that describes steps in a method in accordance with one or more implementations. The method describes an example procedure for ascertaining whether and/or how to initiate a synthetic transaction in accordance with one or more implementations.

Step 500 receives a query requesting that a synthetic transaction be performed over a network. The simulation controller 126, for instance, receives the query from a remote entity, such as the communication service 124 or an endpoint device 102. Alternatively or additionally, the query can be based on an internally-generated event. According to various implementations, the query can be received based on various events and conditions that occur. The query, for instance, can be based on an upcoming calendar event that will involve a communication session. In another example, a user may provide input to initiate a synthetic transaction. In at least some implementations, synthetic transactions may be scheduled to be performed automatically on a periodic basis, such as to test behaviors and attributes of communication lines.

Step 502 ascertains a network condition of the network and a usage parameter for the network. The traffic module 128, for example, determines the network condition, such as based on a query to a remote entity (e.g., a network manager 106) and/or a traffic monitoring procedure implemented by at the simulation controller 126. Generally, the network condition can include various information pertaining to data transmission traffic on the network, such as an amount of traffic (e.g., data transmission) on the network, traffic type(s) on the network (e.g., real time communication, streaming media, non-real time data transfer, and so forth), packet quality on the network, and so on.

Step 504 compares the network condition to the usage parameter to determine whether to perform the synthetic transaction. In at least some implementations, a determination of whether to perform a synthetic transaction on a network is based on an amount of traffic on the network.

For instance, consider that the network condition indicates an amount of bandwidth observed in use (e.g., in active use and/or reserved for use) for real data flows (e.g., data not pertaining to a synthetic transaction) on a network. Further, the usage parameter indicates a bandwidth threshold for the network. The bandwidth threshold, for instance, represents a bandwidth value specified for the network, such as received from a network manager 106 for network and/or stored in the networks DB 136 for the network. Thus, the amount of bandwidth in use is compared to the bandwidth threshold for the network. If the network condition indicates that the amount of bandwidth in use on the network meets (e.g., meets or exceeds) the bandwidth threshold, then the simulation controller 126 decides that the synthetic transaction is not to be performed and/or is to be delayed until the amount of bandwidth in use on the network falls below the bandwidth threshold. If the amount of bandwidth in use is below the bandwidth threshold, the simulation controller 126 determines that the synthetic transaction is to be performed.

As another example, consider that the network condition indicates packet quality on the network. Further, the usage parameter indicates a packet quality threshold. The packet quality threshold may be defined in various ways, such as a threshold PER, a threshold dropped packet count, a threshold jitter value, a threshold RTD, and so forth. Thus, if the packet quality on the network meets the packet quality threshold, the simulation controller 126 determines that the synthetic transaction is to be performed. In at least some implementations, a determination whether to perform a synthetic transaction based on packet quality on a network is dependent on an amount of traffic on the network. For instance, if a comparison of packet quality on a network to a packet quality threshold indicates that a synthetic transaction is to be performed, but an amount of traffic on the network meets a bandwidth threshold, the simulation controller 126 may determine that a synthetic transaction is not to be performed.

If the synthetic transaction is not to be performed (“No”), step 506 does not perform the synthetic transaction. The controller module 130, for example, determines that the synthetic transaction is not to be performed and thus does not proceed with the synthetic transaction. In at least some implementations, the procedure returns to step 502. For instance, network conditions on the network can be monitored in real time. If the network condition subsequently indicate that an amount of traffic on the network falls below a bandwidth threshold, and/or that packet quality on the network meets a packet quality threshold, the controller module 130 may proceed with performing the synthetic transaction.

If the synthetic transaction is to be performed (“Yes”), step 508 determines a performance parameter that indicates how to perform the synthetic transaction. In at least some implementations, determining the performance parameter is based on the network condition for the network.

For example, consider that the network condition indicates an amount of traffic in use for real data transmission on a network. Accordingly, a bandwidth usage and/or data size of a synthetic transaction may be constrained to a relative percentage of the amount of real data transmission. Consider, for instance, that the network condition indicates that x Mbps are currently in use on the network for real data transmission. Accordingly, the synthetic transaction may be limited to using no more than n percent of x Mbps, e.g., no more than 0.02(x) Mbps of bandwidth on the network. As another example, a size of the synthetic transaction may be constrained to a pre-defined data size and/or bandwidth usage, such as y Mb, z Mbps, respectively, and so forth. Thus, the performance parameter may indicate a size limit and/or pre-defined size for the synthetic transaction.

In another example, determining the performance parameter is based on a packet quality observed on the network. For instance, if packet errors on the network meet an error threshold, a rate of synthetic transactions on the network can be increased. Increasing a rate of synthetic transactions, for example, enables a source of packet errors to be more quickly identified.

Step 510 causes the synthetic transaction to be performed according to the performance parameter. The controller module 130, for example, causes a synthetic transaction to be performed on the network 104 and according to the performance parameter. For instance, a size and/or bandwidth usage of the synthetic transaction can be constrained based on the performance parameter. Alternatively or additionally, a rate at which the synthetic transaction and subsequent synthetic transactions are performed is determined based on the performance parameter.

Generally, the synthetic transaction can be performed in various ways. For instance, the simulation controller 126 can instruction an endpoint device 102, a set of endpoint devices 102, and/or the simulated endpoint 140 to initiate the synthetic transaction. Alternatively, the simulation controller 126 can initiate the synthetic transaction, such as with an endpoint device 102 and/or the simulated endpoint 140.

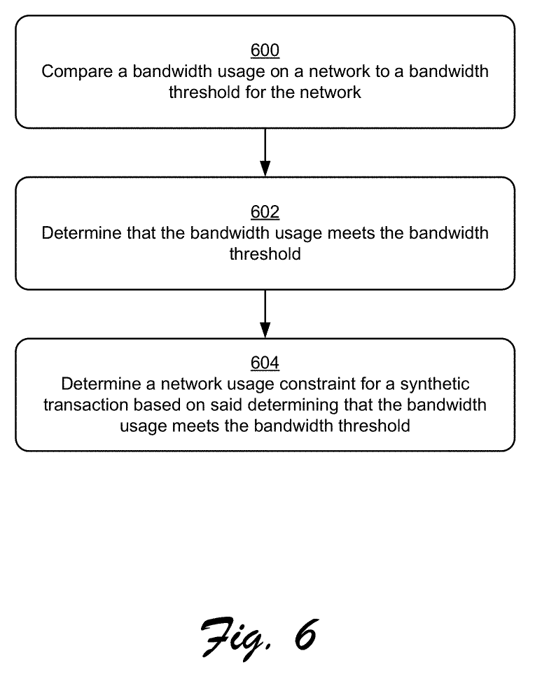

FIG. 6 is a flow diagram that describes steps in a method in accordance with one or more implementations. The method describes an example procedure for considering a bandwidth constraint in performing a synthetic transaction in accordance with one or more implementations.

Step 600 compares a bandwidth usage on a network to a bandwidth threshold for the network. Ways of determining bandwidth usage and a bandwidth threshold are discussed above.

Step 602 determines that the bandwidth usage meets the bandwidth threshold. The simulation controller 126, for example, determines that bandwidth usage on the network 104 meets a bandwidth threshold specified for the network 104.

Step 604 determines a network usage constraint for a synthetic transaction based on said determining that the bandwidth usage meets the bandwidth threshold. Generally, the network usage constraint is to be applied to performing the synthetic transaction. Examples of different usage constraints are discussed above, and include constraints such as a maximum bandwidth usage for the synthetic transaction, a maximum data size for data of a synthetic transaction, a maximum time duration of a synthetic transaction, a maximum occurrence rate for synthetic transactions, and so forth. Thus, a synthetic transaction and/or set of synthetic transactions can be performed subject to the network usage constraint.

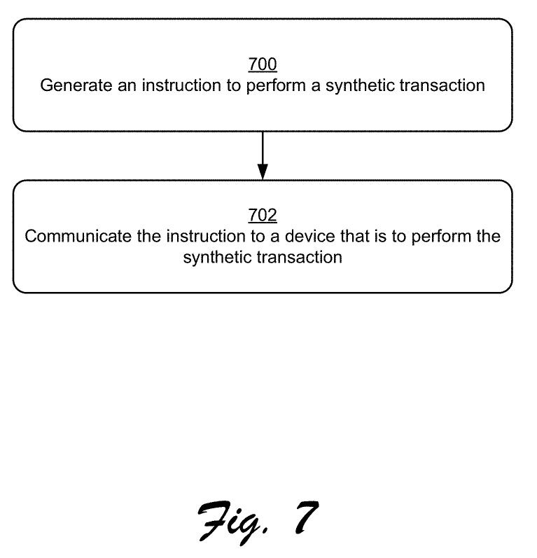

FIG. 7 is a flow diagram that describes steps in a method in accordance with one or more implementations. The method describes an example procedure for causing a synthetic transaction to be performed in accordance with one or more implementations.

Step 700 generates an instruction to perform a synthetic transaction. The instruction, for instance, includes a usage parameter specifying one or more network usage constraints to be applied in performing the synthetic transaction. In at least some implementations, instruction includes a simulation scenario for the synthetic transaction, such as identifiers for various communication endpoints and devices to be involved in the synthetic transaction, parameters for the synthetic transaction, such as settings to be applied (e.g., device and/or communication client settings), type(s) of communication media to be exchanged, behaviors (e.g., user behaviors) to be simulated, timing parameters for the synthetic transaction, and so forth. In at least some implementations, a simulation scenario includes communication media to be exchanged as part of a synthetic transaction, such as voice data, video data, content, and so forth.

Step 702 communicates the instruction to a device that is to perform the synthetic transaction. The simulation controller 126, for example, communicates the instruction to an endpoint device 102, a set of endpoint devices 102, the simulated endpoint 140, and so forth. Generally, the instruction indicates that a receiving device is to implement a synthetic transaction according to parameters included in the instruction, such as a network usage constraint and/or a simulation scenario.

Alternatively or additionally, the simulation controller 126 initiates performance of the synthetic transaction, such as by initiating a simulated communication session with an endpoint device 102, the simulated endpoint 140, and so forth.

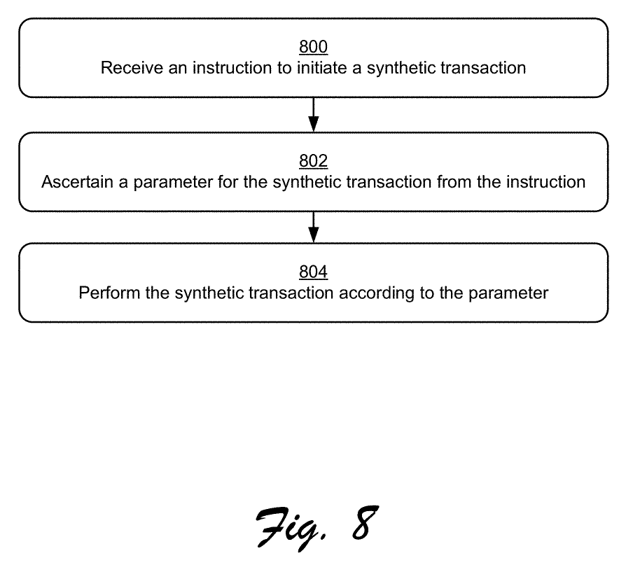

FIG. 8 is a flow diagram that describes steps in a method in accordance with one or more implementations. The method describes an example procedure for performing a synthetic transaction in accordance with one or more implementations.

Step 800 receives an instruction to initiate a synthetic transaction. The instruction, for instance, indicates an instruction to initiate the synthetic transaction between communication clients 110 of different endpoint devices 102. For example, the endpoint device 102a and/or the simulated endpoint 140 receives the instruction from the simulation controller 126.

Step 802 ascertains a parameter for the synthetic transaction from the instruction. The endpoint device 102a, for instance, parses the instruction to identify parameters for the synthetic transaction, such as a network usage constraint and/or a simulation scenario.

Step 804 performs the synthetic transaction according to the parameter. For example, the endpoint device 102a initiates the synthetic transaction according to parameters included in the instruction. The endpoint device 102a, for instance, communicates a request to the endpoint device 102b to initiate a communication session. In at least some implementations, the request may be implemented as a standard call request, such as to participate in a VoIP call and/or other communication session with the client device. The endpoint devices 102a, 102b then exchange communication media specified by and/or included in the simulation scenario. Various parameters specified by the simulation scenario are also implemented, such as a network usage constraint. Examples of such parameters are discussed above.

According to various implementations, the method may be performed to initiate multiple concurrent synthetic transactions with multiple different communication endpoints, such as part of a simulation of a multicast communication session from the client device to multiple different communication endpoints.

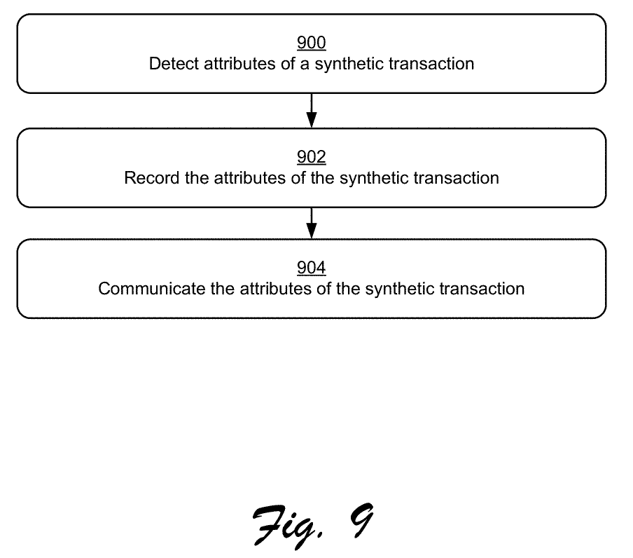

FIG. 9 is a flow diagram that describes steps in a method in accordance with one or more implementations. The method describes an example procedure for logging attributes of a synthetic transaction in accordance with one or more implementations. In at least some implementations, the method describes an example extension of the methods discussed above. The method may be performed by various entities involved and/or associated with a synthetic transaction, such as an endpoint device 102, the simulation controller 126, a network manager 106, and so forth.

Step 900 detects attributes of a synthetic transaction. Generally, the attributes include behaviors and events that occur during the synthetic transaction, such as simulated user input, machine generated events, and so forth. According to various implementations, the attributes also include performance attributes, such as bandwidth experienced during the synthetic transaction, packet latency, jitter, delay, and so forth. The attributes may be detected at various points of a synthetic transaction, such as at initiation, performance, and termination of the synthetic transaction.

In at least some implementations, detected attributes may include quality attributes, such as packet quality, media quality, and so forth. Examples of media quality attributes include sound quality, voice intelligibility, video quality, synchronization quality among media types and/or communication endpoints, and so forth.

Step 902 records the attributes of the synthetic transaction. The attributes, for instance, are logged along with a transaction identifier that differentiates the synthetic transaction from other synthetic transactions and/or communication sessions. The attributes may also be timestamped to indicate a time during the synthetic transaction when the individual attributes were detected. The attributes, for instance, may be tagged as being detected at initiation, performance, or termination of a synthetic transaction.

Step 904 communicates the attributes of the synthetic transaction. The attributes, for instance, may be communicated to various entities, such as entities involved in the synthetic transaction. In at least some implementations, the attributes may be communicated via the communication API 122 discussed above.

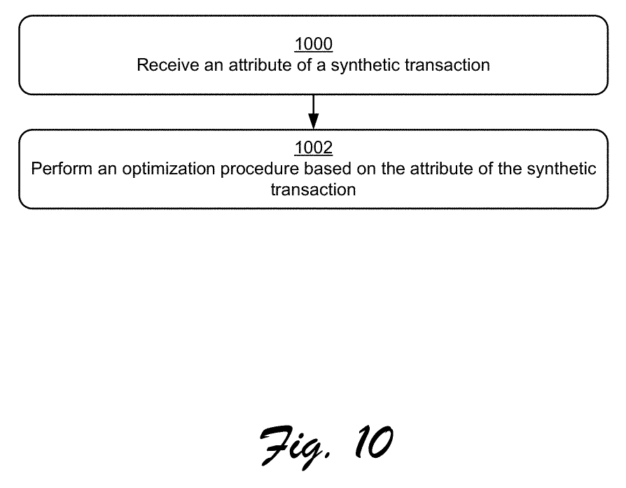

FIG. 10 is a flow diagram that describes steps in a method in accordance with one or more implementations. The method describes an example procedure for performing an optimization procedure based on an attribute of a synthetic transaction in accordance with one or more implementations. In at least some implementations, the method describes an example extension of the methods discussed above. The method may be performed by various entities involved and/or associated with a synthetic transaction, such as an endpoint device 102, the simulation controller 126, a network manager 106, and so forth.

Step 1000 receives an attribute of a synthetic transaction. An endpoint device 102 and/or a network manager 106, for example, receives the attribute from the simulation controller 126. As mentioned above, the attribute can include various packet quality and/or media quality attributes.

Step 1002 performs an optimization procedure based on the attribute of the synthetic transaction. For instance, consider that a network manager 106 for a network 104 determines, based on the attribute, that a particular network component 108 is causing packet errors on the network 104. Accordingly, the network manager 106 can implement an optimization procedure, such as to repair the network component 108 and/or to remove the network component 108 from service such that data communication on the network 104 is not routed through the problematic network component 108.

Consider another example where an endpoint device 102 determines, based on the attribute of the synthetic transaction, that a setting of the endpoint device 102 is to be adjusted to attempt to improve packet quality for data transmission. Thus, the endpoint device 102 can change an internal setting to attempt to improve packet quality, such as be changing a codec rate of the codec 118, increasing error correction (e.g., FEC rate) applied by the error correction module 120, decreasing video bitrate used by the communication client 110, and so forth.

In at least some implementations, techniques discussed herein can be used to test changes that are made in response to detected attributes of a synthetic transaction. For instance, device and/or network attributes can be changed to repair and/or optimize communication performance and based on performance problems detected during a synthetic transaction. After the attributes are changed, a synthetic transaction can be performed to ascertain whether the changes were effective to repair and/or optimize communication performance.

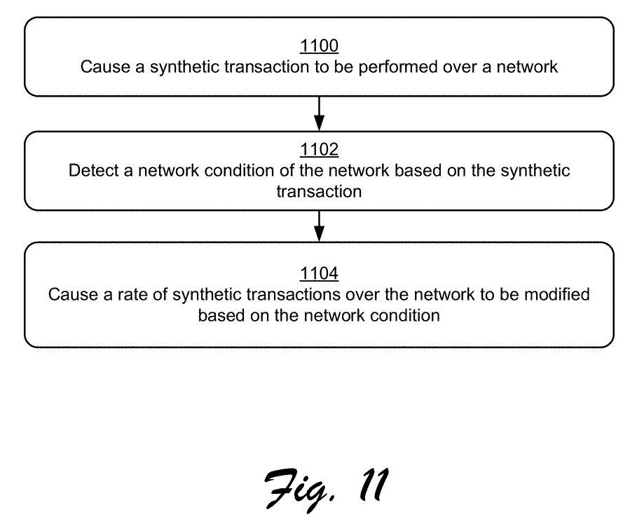

FIG. 11 is a flow diagram that describes steps in a method in accordance with one or more implementations. The method describes an example procedure for modifying a rate of synthetic transactions in accordance with one or more implementations. In at least some implementations, the method describes an example extension of the methods discussed above. The method may be performed by various entities involved and/or associated with a synthetic transaction, such as an endpoint device 102, the simulation controller 126, a network manager 106, and so forth.

Step 1100 causes a synthetic transaction to be performed over a network. Different ways and details for causing synthetic transactions to be performed are discussed above.

Step 1102 detects a network condition of the network based on the synthetic transaction. The network condition, for example, indicates a network condition of the network, an error condition of the network, and so forth. In at least some implementations, the network condition is detected by an endpoint device 102, the simulation controller 126, the communication service 124, and so forth.

Step 1104 causes a rate of synthetic transactions over the network to be modified based on the network condition. For example, if the network condition indicates that bandwidth usage on the network meets a bandwidth threshold, a rate of synthetic transactions on the network can be reduced, such that a number of synthetic transactions performed over a period of time is reduced. As another example, if the network condition indicates that packet errors detected on the network based on the synthetic transaction meets a packet error threshold, a rate of synthetic transactions on the network can be increased. In at least some implementations, increasing a rate of synthetic transactions enables a source of packet errors to be more readily identified by increasing the likelihood that data resulting from a synthetic transaction will be returned, e.g., to the simulation controller 126.

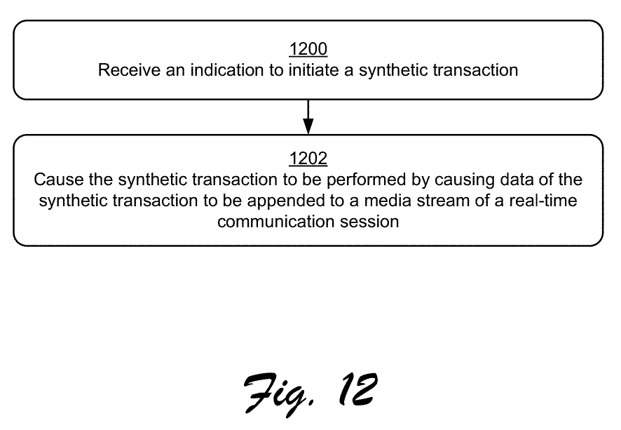

FIG. 12 is a flow diagram that describes steps in a method in accordance with one or more implementations. The method describes an example procedure for performing a synthetic transaction in accordance with one or more implementations. In at least some implementations, the method describes an example extension and/or variation of the methods discussed above. The method may be performed by various entities involved and/or associated with a synthetic transaction, such as an endpoint device 102, the simulation controller 126, a network manager 106, and so forth.

Step 1200 receives an indication to initiate a synthetic transaction. In an example implementation, an endpoint device 102 receives an instruction to perform a synthetic transaction.

Step 1202 causes the synthetic transaction to be performed by causing data of the synthetic transaction to be appended to a media stream of a real-time communication session. The real-time communication session, for instance, represents an exchange of live communication media captured from users of different endpoint devices 102 and included as part of the media stream. Examples of the live communication media include live audio and/or live video captured at an endpoint device 102, such as via interaction with the communication client 110. Accordingly, data of the synthetic transaction can be appended to the live communication media.

Generally, the data of the synthetic transaction represents pre-configured data that is not captured live at the time that the synthetic transaction is performed. The pre-configured data can be generated in various ways, such as pre-recorded audio and/or video, artificially generated (e.g., simulated) audio and/or video, and so forth.

According to various implementations, the data of the synthetic transaction is identified as being part of a synthetic transaction. For instance, the synthetic transaction data includes an identifier that differentiates the synthetic transaction data from the live communication media of the communication session.

Thus, an integrated data stream can be generated that includes live communication media of a real-time communication session along with synthetic transaction data of a communication session. Generally, the different ways of processing and characterizing the synthetic transaction discussed above can be applied based on observations of the integrated data stream. Further, attributes of the synthetic transaction can be controlled based on a detected network condition on a network, such as to increase or decrease an amount of synthetic transaction data, increase or decrease a rate at which real-time communication sessions are appended with synthetic transaction data, and so forth. For instance, ways of controlling a size and/or rate of synthetic transactions discussed above can be applied in the context of a hybrid synthetic transaction that includes both live media data of a communication session, and synthetic transaction data.

Accordingly, techniques described herein can be employed to detect various network traffic conditions and to control whether and how to perform a synthetic transaction based on the network conditions. In this way, synthetic transactions can be managed to reduce interference with network resources during periods of high network usage, while allowing synthetic transactions to be performed to determine communication attributes (e.g., packet quality) on different networks.

Having discussed some example procedures, consider now a discussion of an example system and device in accordance with one or more implementations.

FIG. 13 illustrates an example system generally at 1300 that includes an example computing device 1302 that is representative of one or more computing systems and/or devices that may implement various techniques described herein. For example, the endpoint devices 102, the network managers 106, and/or the simulation controller 126 discussed above with reference to FIG. 1 can be embodied as the computing device 1302. The computing device 1302 may be, for example, a server of a service provider, a device associated with the client (e.g., a client device), an on-chip system, and/or any other suitable computing device or computing system.

The example computing device 1302 as illustrated includes a processing system 1304, one or more computer-readable media 1306, and one or more Input/Output (I/O) Interfaces 1308 that are communicatively coupled, one to another. Although not shown, the computing device 1302 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 1304 is representative of functionality to perform one or more operations using hardware. Accordingly, the processing system 1304 is illustrated as including hardware element 1310 that may be configured as processors, functional blocks, and so forth. This may include implementation in hardware as an application specific integrated circuit or other logic device formed using one or more semiconductors. The hardware elements 1310 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 1306 is illustrated as including memory/storage 1312. The memory/storage 1312 represents memory/storage capacity associated with one or more computer-readable media. The memory/storage 1312 may include volatile media (such as random access memory (RAM)) and/or nonvolatile media (such as read only memory (ROM), Flash memory, optical disks, magnetic disks, and so forth). The memory/storage 1312 may include fixed media (e.g., RAM, ROM, a fixed hard drive, and so on) as well as removable media (e.g., Flash memory, a removable hard drive, an optical disc, and so forth). The computer-readable media 1306 may be configured in a variety of other ways as further described below.

Input/output interface(s) 1308 are representative of functionality to allow a user to enter commands and information to computing device 1302, and also allow information to be presented to the user and/or other components or devices using various input/output devices. Examples of input devices include a keyboard, a cursor control device (e.g., a mouse), a microphone (e.g., for voice recognition and/or spoken input), a scanner, touch functionality (e.g., capacitive or other sensors that are configured to detect physical touch), a camera (e.g., which may employ visible or non-visible wavelengths such as infrared frequencies to detect movement that does not involve touch as gestures), and so forth. Examples of output devices include a display device (e.g., a monitor or projector), speakers, a printer, a network card, tactile-response device, and so forth. Thus, the computing device 1302 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 1302. By way of example, and not limitation, computer-readable media may include “computer-readable storage media” and “computer-readable signal media.”

“Computer-readable storage media” may refer to media and/or devices that enable persistent storage of information in contrast to mere signal transmission, carrier waves, or signals per se. Computer-readable storage media do not include signals per se. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 1302, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, radio frequency (RF), infrared, and other wireless media.

As previously described, hardware elements 1310 and computer-readable media 1306 are representative of instructions, modules, programmable device logic and/or fixed device logic implemented in a hardware form that may be employed in some implementations to implement at least some aspects of the techniques described herein. Hardware elements may include components of an integrated circuit or on-chip system, an application-specific integrated circuit (ASIC), a field-programmable gate array (FPGA), a complex programmable logic device (CPLD), and other implementations in silicon or other hardware devices. In this context, a hardware element may operate as a processing device that performs program tasks defined by instructions, modules, and/or logic embodied by the hardware element as well as a hardware device utilized to store instructions for execution, e.g., the computer-readable storage media described previously.

Combinations of the foregoing may also be employed to implement various techniques and modules described herein. Accordingly, software, hardware, or program modules and other program modules may be implemented as one or more instructions and/or logic embodied on some form of computer-readable storage media and/or by one or more hardware elements 1310. The computing device 1302 may be configured to implement particular instructions and/or functions corresponding to the software and/or hardware modules. Accordingly, implementation of modules that are executable by the computing device 1302 as software may be achieved at least partially in hardware, e.g., through use of computer-readable storage media and/or hardware elements 1310 of the processing system. The instructions and/or functions may be executable/operable by one or more articles of manufacture (for example, one or more computing devices 1302 and/or processing systems 1304) to implement techniques, modules, and examples described herein.

As further illustrated in FIG. 13, the example system 1300 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 1300, multiple devices are interconnected through a central computing device. The central computing device may be local to the multiple devices or may be located remotely from the multiple devices. In one implementation, the central computing device may be a cloud of one or more server computers that are connected to the multiple devices through a network, the Internet, or other data communication link.

In one implementation, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one implementation, a class of target devices is created and experiences are tailored to the generic class of devices. A class of devices may be defined by physical features, types of usage, or other common characteristics of the devices.

In various implementations, the computing device 1302 may assume a variety of different configurations, such as for computer 1314, mobile 1316, and television 1318 uses. Each of these configurations includes devices that may have generally different constructs and capabilities, and thus the computing device 1302 may be configured according to one or more of the different device classes. For instance, the computing device 1302 may be implemented as the computer 1314 class of a device that includes a personal computer, desktop computer, a multi-screen computer, laptop computer, netbook, and so on.

The computing device 1302 may also be implemented as the mobile 1316 class of device that includes mobile devices, such as a mobile phone, portable music player, portable gaming device, a tablet computer, a multi-screen computer, wearable devices, and so on. The computing device 1302 may also be implemented as the television 1318 class of device that includes devices having or connected to generally larger screens in casual viewing environments. These devices include televisions, set-top boxes, gaming consoles, and so on.

The techniques described herein may be supported by these various configurations of the computing device 1302 and are not limited to the specific examples of the techniques described herein. For example, functionalities discussed with reference to the entities of the environment 100 may be implemented all or in part through use of a distributed system, such as over a “cloud” 1320 via a platform 1322 as described below.

The cloud 1320 includes and/or is representative of a platform 1322 for resources 1324. The platform 1322 abstracts underlying functionality of hardware (e.g., servers) and software resources of the cloud 1320. The resources 1324 may include applications and/or data that can be utilized while computer processing is executed on servers that are remote from the computing device 1302. Resources 1324 can also include services provided over the Internet and/or through a subscriber network, such as a cellular or Wi-Fi network.

The platform 1322 may abstract resources and functions to connect the computing device 1302 with other computing devices. The platform 1322 may also serve to abstract scaling of resources to provide a corresponding level of scale to encountered demand for the resources 1324 that are implemented via the platform 1322. Accordingly, in an interconnected device implementation, implementation of functionality described herein may be distributed throughout the system 1300. For example, the functionality may be implemented in part on the computing device 1302 as well as via the platform 1322 that abstracts the functionality of the cloud 1320.

Discussed herein are a number of methods that may be implemented to perform techniques discussed herein. Aspects of the methods may be implemented in hardware, firmware, or software, or a combination thereof. The methods are shown as a set of steps that specify operations performed by one or more devices and are not necessarily limited to the orders shown for performing the operations by the respective blocks. Further, an operation shown with respect to a particular method may be combined and/or interchanged with an operation of a different method in accordance with one or more implementations. Aspects of the methods can be implemented via interaction between various entities discussed above with reference to the environment 100.

Techniques for a synthetic transaction based on a network condition are described. Although implementations are described in language specific to structural features and/or methodological acts, it is to be understood that the implementations defined in the appended claims are not necessarily limited to the specific features or acts described. Rather, the specific features and acts are disclosed as example forms of implementing the claimed implementations.

In the discussions herein, various different implementations are described. It is to be appreciated and understood that each implementation described herein can be used on its own or in connection with one or more other implementations described herein. Further aspects of the techniques discussed herein relate to one or more of the following implementations.

A system for determining whether or how to perform a synthetic transaction, the system comprising: at least one processor; and one or more computer-readable storage media including instructions stored thereon that, responsive to execution by the at least one processor, cause the system perform operations including: receiving a query requesting that a synthetic transaction be performed over a network; ascertaining a network condition of the network and a usage parameter for the network; and determining, as a function of a comparison of the network condition to the usage parameter, one or more of whether to perform the synthetic transaction, or how to perform the synthetic transaction.

In addition to any of the above described systems, any one or combination of: wherein the query is based on a communication session that is scheduled to occur over the network; wherein said ascertaining the network condition comprises querying the network for the network condition; wherein said ascertaining the network condition comprises observing traffic on the network; wherein the network condition comprises one or more of an amount of bandwidth usage on the network, or an indication of packet quality on the network; wherein the network condition comprises a bandwidth usage on the network, the usage parameter comprises a bandwidth threshold, and said comparing comprises comparing the bandwidth usage to the bandwidth threshold to determine one of more of whether to perform the synthetic transaction, or how to perform the synthetic transaction; wherein the network condition comprises a bandwidth usage on the network, the usage parameter comprises a bandwidth threshold, and said comparing comprises: comparing the bandwidth usage to the bandwidth threshold; determining that the bandwidth usage meets the bandwidth threshold; and determining to not perform the synthetic transaction based on said determining that the bandwidth usage meets the bandwidth threshold; wherein the network condition comprises a bandwidth usage on the network, the usage parameter comprises a bandwidth threshold, and said comparing comprises: comparing the bandwidth usage to the bandwidth threshold; determining that the bandwidth usage meets the bandwidth threshold; and determining a network usage constraint for the synthetic transaction based on said determining that the bandwidth usage meets the bandwidth threshold, the network usage constraint indicating a maximum data size of the synthetic transaction; wherein the network condition comprises a bandwidth usage on the network, the usage parameter comprises a bandwidth threshold, and said comparing comprises: comparing the bandwidth usage to a bandwidth threshold; determining that the bandwidth usage meets the bandwidth threshold; and determining a network usage constraint for the synthetic transaction based on said determining that the bandwidth usage meets the bandwidth threshold, the network usage constraint indicating a maximum bandwidth usage for the synthetic transaction; wherein the network condition comprises a packet quality condition on the network, the usage parameter comprises an error threshold, and said comparing comprises: comparing the packet quality condition to the error threshold; determining that the packet quality condition meets the error threshold; and determining to perform the synthetic transaction and to increase a frequency of synthetic transactions over the network based on said determining.

A computer-implemented method for causing a rate of synthetic transactions to be modified, the method comprising: causing a synthetic transaction to be performed over a network; detecting a network condition of the network based on the synthetic transaction, the network condition indicating one or more of a network condition of the network, or an error condition of the network; and causing a rate of synthetic transactions over the network to be modified based on the network condition.

In addition to any of the above described methods, any one or combination of: wherein said causing comprises instructing a network node to perform the synthetic transaction; wherein the network condition comprises an error condition, and wherein said causing comprises increasing the frequency of synthetic transactions over the network based on the error condition; wherein the network condition comprises an error condition that indicates that a number of errors detected as part of the synthetic transaction exceeds an error threshold, and wherein said causing comprises increasing the frequency of synthetic transactions over the network based on the error condition; wherein the network condition comprises a network condition indicating that an amount of traffic on the network meets a traffic threshold, and wherein said causing comprises decreasing the frequency of synthetic transactions over the network.

A computer-implemented method for causing a synthetic transaction to be performed, the method comprising: receiving an indication to initiate a synthetic transaction; and causing the synthetic transaction to be performed by causing data of the synthetic transaction to be appended to a media stream of a real-time communication session. A method as described in claim 16, wherein said receiving comprises receiving the indication from a communication service that manages the real-time communication session.

In addition to any of the above described methods, any one or combination of: wherein the data of the synthetic transaction comprises simulated communication media that is appended to the media stream of the real-time communication session; wherein the data of the synthetic transaction includes an identifier that differentiates the data from media data of the real-time communication session; wherein said causing comprises causing the synthetic transaction to be initiated in conjunction with initiation of the real-time communication session.

What is claimed is:

1. A system comprising:
at least one processor; and
one or more computer-readable storage media including instructions stored thereon that, responsive to execution by the at least one processor, cause the system perform operations including:
receiving a query requesting that a synthetic transaction be performed over a network;
ascertaining a network condition of the network and a usage parameter for the network; and
determining, as a function of a comparison of the network condition to the usage parameter, one or more of whether to perform the synthetic transaction, or how to perform the synthetic transaction.

2. A system as recited in claim 1, wherein the query is based on a communication session that is scheduled to occur over the network.

3. A system as recited in claim 1, wherein said ascertaining the network condition comprises querying the network for the network condition.

4. A system as recited in claim 1, wherein said ascertaining the network condition comprises observing traffic on the network.

5. A system as recited in claim 1, wherein the network condition comprises one or more of an amount of bandwidth usage on the network, or an indication of packet quality on the network.

6. A system as recited in claim 1, wherein the network condition comprises a bandwidth usage on the network, the usage parameter comprises a bandwidth threshold, and said comparing comprises comparing the bandwidth usage to the bandwidth threshold to determine one of more of whether to perform the synthetic transaction, or how to perform the synthetic transaction.

7. A system as recited in claim 1, wherein the network condition comprises a bandwidth usage on the network, the usage parameter comprises a bandwidth threshold, and said comparing comprises:
comparing the bandwidth usage to the bandwidth threshold;
determining that the bandwidth usage meets the bandwidth threshold; and
determining to not perform the synthetic transaction based on said determining that the bandwidth usage meets the bandwidth threshold.

8. A system as recited in claim 1, wherein the network condition comprises a bandwidth usage on the network, the usage parameter comprises a bandwidth threshold, and said comparing comprises:
comparing the bandwidth usage to the bandwidth threshold;
determining that the bandwidth usage meets the bandwidth threshold; and
determining a network usage constraint for the synthetic transaction based on said determining that the bandwidth usage meets the bandwidth threshold, the network usage constraint indicating a maximum data size of the synthetic transaction.

9. A system as recited in claim 1, wherein the network condition comprises a bandwidth usage on the network, the usage parameter comprises a bandwidth threshold, and said comparing comprises:
comparing the bandwidth usage to a bandwidth threshold;
determining that the bandwidth usage meets the bandwidth threshold; and
determining a network usage constraint for the synthetic transaction based on said determining that the bandwidth usage meets the bandwidth threshold, the network usage constraint indicating a maximum bandwidth usage for the synthetic transaction.

10. A system as recited in claim 1, wherein the network condition comprises a packet quality condition on the network, the usage parameter comprises an error threshold, and said comparing comprises:
comparing the packet quality condition to the error threshold;
determining that the packet quality condition meets the error threshold; and
determining to perform the synthetic transaction and to increase a frequency of synthetic transactions over the network based on said determining.

11. A computer-implemented method, comprising:
causing a synthetic transaction to be performed over a network;
detecting a network condition of the network based on the synthetic transaction, the network condition indicating one or more of a network condition of the network, or an error condition of the network; and
causing a rate of synthetic transactions over the network to be modified based on the network condition.

12. A method as described in claim 11, wherein said causing comprises instructing a network node to perform the synthetic transaction.

13. A method as described in claim 11, wherein the network condition comprises an error condition, and wherein said causing comprises increasing the frequency of synthetic transactions over the network based on the error condition.

14. A method as described in claim 11, wherein the network condition comprises an error condition that indicates that a number of errors detected as part of the synthetic transaction exceeds an error threshold, and wherein said causing comprises increasing the frequency of synthetic transactions over the network based on the error condition.

15. A method as described in claim 11, wherein the network condition comprises a network condition indicating that an amount of traffic on the network meets a traffic threshold, and wherein said causing comprises decreasing the frequency of synthetic transactions over the network.

16. A computer-implemented method, comprising:
receiving an indication to initiate a synthetic transaction; and
causing the synthetic transaction to be performed by causing data of the synthetic transaction to be appended to a media stream of a real-time communication session.

17. A method as described in claim 16, wherein said receiving comprises receiving the indication from a communication service that manages the real-time communication session.

18. A method as described in claim 16, wherein the data of the synthetic transaction comprises simulated communication media that is appended to the media stream of the real-time communication session.

19. A method as described in claim 16, wherein the data of the synthetic transaction includes an identifier that differentiates the data from media data of the real-time communication session.

20. A method as described in claim 16, wherein said causing comprises causing the synthetic transaction to be initiated in conjunction with initiation of the real-time communication session.
